(19) United States
(12) Patent Application Publication
(10) Pub. No.: US 2024/0127495 A1
(43) Pub. Date: Apr. 18, 2024

(54) VIRTUAL SCENE PRESENTATION METHOD, APPARATUS, DEVICE, AND MEDIUM

(71) Applicant: Beijing Zitiao Network Technology Co., Ltd., Beijing (CN)

(72) Inventors: Ziyuan LIU, Beijing (CN); Shuai WANG, Beijing (CN); Wenhao CHENG, Beijing (CN); Zhanyi YAN, Beijing (CN)

(21) Appl. No.: 18/471,132

(22) Filed: Sep. 20, 2023

(30) Foreign Application Priority Data
Oct. 14, 2022 (CN) 202211263288.2

(51) Int. Cl. G06T 11/00; G06F 3/16; G06F 40/279; G06V 10/44; G06V 10/74; G06V 10/764; G06V 20/20; G06V 20/50; G06V 20/70

(52) U.S. Cl. CPC G06T 11/00; G06F 3/165; G06F 40/279; G06V 10/44; G06V 10/74; G06V 10/764; G06V 20/20; G06V 20/50; G06V 20/70

(57) ABSTRACT

The present disclosure provides a virtual scene presentation method, apparatus, device, and storage medium, the method comprising: identifying a physical object set in an environment space; determining a scene type corresponding to the environment space; obtaining a virtual scene set associated with the scene type; and presenting a virtual scene in the virtual scene set on at least part of physical objects in the physical object set.

### CROSS-REFERENCE TO RELATED APPLICATIONS

The present application is based on and claims priority to Chinese Patent Application No. 202211263288.2 filed on Oct. 14, 2022, and entitled “VIRTUAL SCENE PRESENTATION METHOD, APPARATUS, DEVICE, AND MEDIUM”, the disclosure of which is incorporated by reference herein in its entirety.

### TECHNICAL FIELD

The present disclosure relates to the technical field of Mixed Reality, and in particular, to a virtual scene presentation method, apparatus, device, and medium.

### BACKGROUND

Mixed Reality (MR) refers to the combination of real and virtual worlds to create a new environment and visualization, where physical entities and digital objects coexist and can interact in real time to simulate real objects. Reality, augmented reality, augmented virtuality, and virtual reality technologies are mixed.

In the current MR scene, a single virtual scene is generally rendered and presented based on a proprietary solution for a specific space. Therefore, the rendering solution for the virtual scene is single, cannot enable a user to experience diversified virtual scenes in the same space and cannot meet diversified experience requirements for the MR scene.

### SUMMARY

In order to solve the above technical problem, or at least partially solve the above technical problem, the present disclosure provides a virtual scene presentation method, apparatus, device, and medium.

In a first aspect, the present disclosure provides a virtual scene presentation method, comprising:
identifying a physical object set in an environment space;
determining a scene type corresponding to the environment space;
obtaining a virtual scene set associated with the scene type; and
presenting a virtual scene in the virtual scene set on at least part of physical objects in the physical object set.

In a second aspect, the present disclosure provides a virtual scene presentation apparatus, comprising:
an identification module configured to identify a physical object set in an environment space;
a determination module configured to determine a scene type corresponding to the environment space;
an obtaining module configured to obtain a virtual scene set associated with the scene type; and
a presentation module configured to present a virtual scene in the virtual scene set on at least part of physical objects in the physical object set.

In a third aspect, the present disclosure provides a non-transitory computer-readable storage medium, having therein stored instructions which, when run on a terminal device, cause the terminal device to implement the method described above.

In a fourth aspect, the present disclosure provides a device, comprising: a memory, a processor, and a computer program stored on the memory and being runnable on the processor, the computer program, when executed by the processor, implements the method described above.

In a fifth aspect, the present disclosure provides a computer program product comprising a computer program or instructions which, when executed by a processor, implements the method described above.

### BRIEF DESCRIPTION OF THE DRAWINGS

The accompanying drawings here, which are incorporated in and constitute a part of this specification, illustrate embodiments consistent with the present disclosure and, together with the description, serve to explain the principles of the present disclosure.

In order to more clearly illustrate the embodiments of the present disclosure or technical solutions in the prior art, the drawings that need to be used in the description of the embodiments or the prior art will be briefly described below, and it is obvious for those skilled in the art that other drawings can be obtained according to these drawings without paying out creative efforts.

FIG. 1 is a schematic flow diagram of a virtual scene presentation method provided in an embodiment of the present disclosure;

FIG. 2 is a schematic structural diagram of a virtual scene presentation apparatus provided in an embodiment of the present disclosure;

FIG. 3 is a schematic structural diagram of a virtual scene presentation device provided in an embodiment of the present disclosure.

### DETAILED DESCRIPTION

In order that the above objectives, features and advantages of the present disclosure may be more clearly understood, the solutions of the present disclosure will be further described below. It should be noted that, in the case of no conflict, the embodiments of the present disclosure and features in the embodiments may be combined with each other.

In the following description, numerous specific details are set forth in order to facilitate thorough understanding of the present disclosure, but the present disclosure may be practiced otherwise than as described herein; and it is obvious that the embodiments in the description are only part of the embodiments of the present disclosure, and not all of the embodiments.

MR is Mixed Reality, a mixture of VR (Virtual Reality) and AR (Augmented Reality). Specifically, in the MR, human eyes are replaced with a camera and a computer for performing machine vision such as identification, tracking, measurement on a target, and image processing is further made to process, by using the computer, image to be more suitable for observation by the human eyes or transmission to an instrument for detection.

A current virtual scene presentation mode is to render, in a specific space, a virtual scene corresponding to the specific space by employing a proprietary solution. For example, in such a special scene as a classroom, a virtual starry sky scene is rendered by using rendering software in astronomy, such that students are immersed in the virtual starry sky scene to learn astronomical knowledge up close.

However, only one virtual scene corresponding to the specific space can be rendered by using the proprietary solution in the specific space, so that the rendering of the virtual scene is poor in flexibility.

In order to solve the above problem, an embodiment of the present disclosure provides a virtual scene presentation method, apparatus, device, and medium. The virtual scene presentation method can be applied to an electronic device or a server for providing virtual scene presentation.

Compared with the prior art, the technical solutions provided by embodiments of the present disclosure have at least the following advantages:
the embodiments of the present disclosure provide a virtual scene presentation method, apparatus, device, and medium, wherein the method comprises: identifying a physical object set in an environment space; determining a scene type corresponding to the environment space; obtaining a virtual scene set associated with the scene type; and presenting a virtual scene in the virtual scene set on at least part of physical objects in the physical object set. In this manner, various physical objects in the environment space can be flexibly combined to determine virtual scenes corresponding to different scene types, and therefore, the rendering solution for the virtual scene has more flexibility, so that various virtual scenes can be rendered, and diversified experience requirements of users for the MR scene are met.

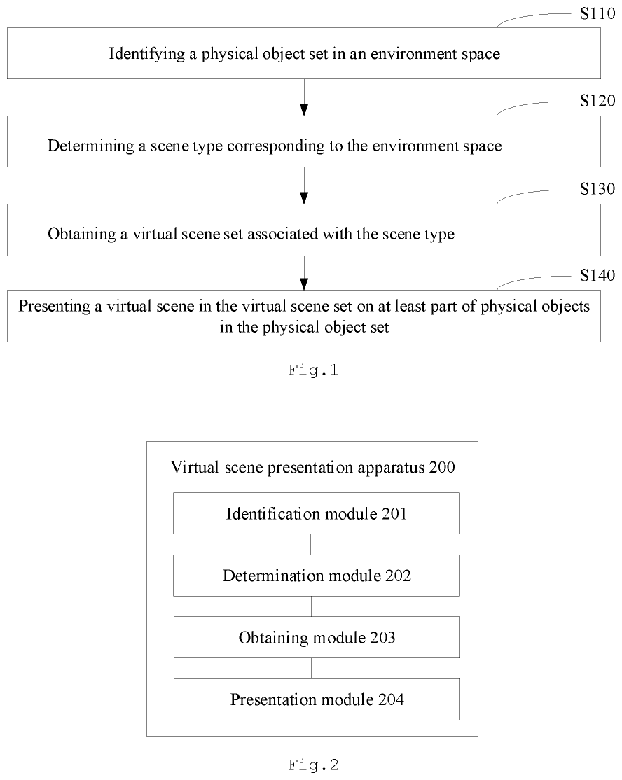

FIG. 1 shows a schematic flow diagram of a virtual scene presentation method provided in an embodiment of the present disclosure. As shown in FIG. 1, the virtual scene presentation method comprises the following steps.

S110, identifying a physical object set in an environment space.

In this embodiment, when a user wants to experience a virtual scene, a presentation request for the virtual scene is sent to an electronic device inside the environment space where the user is located, and the electronic device identifies a physical object set capable of rendering the virtual scene from the environment space, so that physical objects in the physical object set are further flexibly combined, to render and present the virtual scene.

The environment space refers to a real physical space needing to render a virtual scene. For example, the environment space is a bedroom, a living room, a study room, an office, a shop in a mall, etc.

The physical object set comprises a plurality of physical objects, and each physical object is pre-labeled with a label, so that according to a label pre-labeled, its corresponding physical object may be determined. The physical object may be understood as an object actually present in the environment space. In some embodiments, the physical object may include a floor, a wall, a door, a window, a ceiling, furniture, etc., and the labels corresponding to the physical objects may be represented as wall01, wall02, door01, door02, etc.

Specifically, the electronic device may perform image acquisition on the environment space, and parse a position of each pixel and a pixel value of each pixel in an image, to identify the physical object included in the environment space according to the position data and the pixel value of each pixel, and combine a plurality of physical objects into a physical object set.

S120, determining a scene type corresponding to the environment space.

In this embodiment, before a virtual scene is rendered based on the physical objects in the physical object set, scene information of the environment space needs to be detected, and the scene type currently corresponding to the environment space is determined according to the scene information, so that a virtual scene consistent with the scene type is subsequently rendered.

The scene information can be understood as light intensity, position, time, and other information of the environment space. The scene type refers to a classification of a scene to be rendered in the environment space, and one scene type may be associated with one or more specific virtual scenes.

For example, scene types include a daytime type and a nighttime type. The daytime type includes, but is not limited to, specific virtual scenes such as a sunny beach, an alpine forest, a tropical rainforest, a Nordic snow house, and a countryside scene. The nighttime type includes specific virtual scenes such as the cosmic galaxy, Mars landing, a spaceship, and a submarine world.

As another example, scene types include an indoor scene type and an outdoor scene type. The indoor scene type includes, but is not limited to, specific virtual scenes such as classroom interaction, emergency treatment, and indoor construction. The outdoor scene type includes specific virtual scenes such as rocket launching, and river flowing.

S130, obtaining a virtual scene set associated with the scene type.

It can be understood that each scene type may be pre-associated with one or more specific virtual scenes, and each virtual scene is associated with one scene, and therefore, one or more virtual scenes associated with a scene type can be directly found based on the scene type, and a virtual scene set is constituted by the one or more virtual scenes.

For example, scene types includes a daytime type and a nighttime type. The daytime type is associated with specific virtual scenes such as a sunny beach, an alpine forest, a tropical rainforest, a Nordic snow house, and a countryside scene, so that a virtual scene set associated with the daytime type is constituted by the specific virtual scenes such as a sunny beach, an alpine forest, a tropical rainforest, a Nordic snow house, and a countryside scene. The nighttime type includes specific virtual scenes such as the cosmic galaxy, Mars landing, a spaceship, and a submarine world, so that a virtual scene set associated with the nighttime type is constituted by the specific virtual scenes such as the cosmic galaxy, Mars landing, a spaceship, and a submarine world.

S140, presenting a virtual scene in the virtual scene set on at least part of physical objects in the physical object set.

In this embodiment, for each virtual scene in the virtual scene set, a corresponding rendering template exists, so that based on the rendering template corresponding to each virtual scene, part of physical objects required by the virtual scene may be determined, and then the part of physical objects are combined to render the virtual scene, and the virtual scene is presented.

In an embodiment of the present disclosure, optionally, the S140 specifically comprises the following steps:
obtaining a target physical object from the physical object set according to indication information of the user;
extracting a current feature value of each pixel point of the target physical object;
obtaining a reference feature value corresponding to each pixel point of the target physical object according to a virtual scene to be presented; and
comparing the current feature value and the reference feature value of each pixel point of the target physical object, determining whether to update the current feature value according to a comparison result, and presenting the virtual scene in the virtual scene set by an update result.

The indication information of the user is used for indicating a physical object to be virtualized, as the target physical object. In some embodiments, the indication information of the user may include, but is not limited to, a position to which a user finger points, mouse selection of the user, and a physical object selection instruction issued by the user.

The current feature value may include a combination of one or more of a color value, transparency, and a depth value corresponding to each pixel point on the physical object. Specifically, a fragment by fragment operation may be performed on the target physical object, to extract the current feature value of each pixel point of the target physical object.

The reference feature value refers to a preset reference value of each pixel point, which is compared with the current feature value corresponding to each pixel point, to determine whether to update the current feature value corresponding to each pixel point according to a comparison result.

Specifically, for each pixel point, a template test, a transparency test, and a depth test may be performed. In practice, the template test follows the transparency test and precedes the depth test.

In the process of the transparency test, starting with a first pixel point, the transparency test is performed; for a current pixel point, current transparency and reference transparency corresponding to the current pixel point are compared, if the current transparency is greater than the reference transparency, the current transparency of the current pixel point is updated, and specifically, the current transparency of the current pixel point can be updated as the reference transparency; the above operation is continued until the current pixel point is the last pixel point, so that the process of the transparency test for the target physical object is completed.

In the process of the template test, starting with a first pixel point, the template test is performed; for a current pixel point, a current color value and a reference color value corresponding to the current pixel point are compared, if the current color value is greater than the reference color value, the current color value of the current pixel point is updated, and specifically, the current color value of the current pixel point can be updated as the reference color value; the above operation is continued until the current pixel point is the last pixel point, so that the process of the template test for the target physical object is completed.

In the process of the depth test, starting with a first pixel point, the depth test is performed; for a current pixel point, a current depth value and a reference depth value corresponding to the current pixel point are compared, if the current depth value is greater than the reference depth value, the current depth value of the current pixel point is updated, and specifically, the current depth value of the current pixel point can be updated as the reference depth value; the above operation is continued until the current pixel point is the last pixel point, so that the process of the depth test for the target physical object is completed.

Further, after the transparency test, the template test, and the depth test for the target physical object are completed, the virtual scene in the virtual scene set is rendered and presented.

In one example, an environment space is a bedroom, a scene type of a virtual scene is a daytime type, a virtual scene is a sunny beach, positions to which a user finger points in turn are a ceiling, a wall, a door, a window, a floor, furniture and the like, then the ceiling, the wall, the door, the window, the floor and the furniture are taken as target physical objects, and the ceiling has a blue sky and the sun presented, one wall or four walls have a beach and a sea presented, and the door, the window, the floor and the furniture keep information of a real physical world.

In another example, an environment space is a bedroom, a scene type of a virtual scene is a nighttime type, a virtual scene set is the cosmic galaxy, positions to which a user finger points in turn are a ceiling, a wall, a door, a window, a floor, furniture and the like, then the ceiling, the wall, the door, the window, the floor and the furniture are taken as target physical objects, and the ceiling and one or four walls have the cosmic galaxy presented, and the door, the window, the floor and the furniture keep information of a real physical world.

In yet another example, an environment space is a bedroom, a scene type of a virtual scene is a nighttime type, a virtual scene set is a submarine world, positions to which a user finger points in turn are a ceiling, a wall, a door, a window, a floor, furniture and the like, then the ceiling, the wall, the door, the window, the floor and the furniture are taken as target physical objects, and the ceiling, the floor and one or four walls have the submarine world presented, and the furniture keeps information of a real physical world.

Therefore, different virtual scenes can be rendered based on the current feature value of each pixel point and the corresponding reference feature value of the pixel point, which ensures that the different virtual scenes can be flexibly presented. In addition, the above virtual scene presentation method can be understood as an another-dimensional portal, which is specifically to fuse a physical object into a reality scene and form a virtual scene presentation tool.

An embodiment of the present disclosure provides a virtual scene presentation method comprising: identifying a physical object set in an environment space; determining a scene type corresponding to the environment space; obtaining a virtual scene set associated with the scene type; and presenting a virtual scene in the virtual scene set on at least part of physical objects in the physical object set. In this manner, various physical objects in the environment space can be flexibly combined to determine virtual scenes corresponding to different scene types, and therefore, the rendering solution for the virtual scene has more flexibility, so that various virtual scenes are rendered to meet diversified experience requirements of users for the MR scene.

In another implementation of the present disclosure, the scene type can be determined in a different manner. Additionally, it is possible to determine the virtual scene set in conjunction with virtual scene content and update the virtual scene set based on user input.

In some embodiments of the present disclosure, the S120 may specifically comprise the following steps:
obtaining time information and/or location information of the environment space; and
determining the scene type corresponding to the environment space according to the time information and/or the location information.

The time information may be understood as current time of different areas. The location information may be understood as longitude and latitude information.

In some embodiments, the scene type corresponding to the environment space is a daytime type or a nighttime type.

It can be understood that, due to the rotation of the earth, it can be determined whether the scene type corresponding to the environment space is the daytime type or the nighttime type based on the current time and/or the longitude and latitude.

Therefore, it can be simply and accurately determined whether the scene type corresponding to the environment space is the daytime type or the nighttime type based on the time information and/or the location information of the environment space.

In other embodiments of the present disclosure, the S120 may specifically comprise the following steps:
detecting whether there is a preset key object in the physical object set; and
if it is learned from detection that there is the key object, querying preset scene type information corresponding to the key object, to determine the scene type corresponding to the environment space.

The key object is a physical object capable of characterizing the scene type.

In some embodiments, the scene type corresponding to the environment space is an office type, or a bedroom type, or a study room type.

It can be appreciated that different scene types correspond to different key objects. For example, the scene type is an office type, then the key object includes rows of desks and a plurality of computers; for another example, the scene type is a bedroom type, then the key object includes a bed, a wardrobe, and a bedside table; and for another example, the scene type is a study room type, then the key object includes a desk and a bookshelf.

Therefore, it is possible to accurately determine the scene type corresponding to the key object based on the key object detected from the environment space.

Further, in some embodiments of the present disclosure, the S130 may specifically comprise the following steps:
parsing content of a candidate virtual scene, and extracting a scene label of the candidate virtual scene; and
matching the scene label with the scene type, and screening out a candidate virtual scene successfully matched as the virtual scene set associated with the scene type.

The content of the candidate virtual scene refers to classical content of the candidate virtual scene, which is representative content of the candidate virtual scene; different representative contents are pre-matched with scene labels, so that the candidate virtual scene is associated with the scene label.

It can be understood that the scene type and the virtual scene may be in a one-to-one relation, and may be in a one-to-multiple relation. By matching the scene label with the scene type, one or more candidate virtual scenes successfully matched can be screened out, so that the virtual scene set associated with the scene type is obtained.

Exemplarily, if the parsed content of the candidate virtual scene includes blue sky and white cloud, a scene label 01 of the candidate virtual scene is extracted based on the blue sky and the white cloud, and a scene type matched with the scene label is a daytime type, then a virtual scene set associated with the daytime type includes virtual scenes such as a sunny beach and a countryside scene.

Further, the virtual scene set may also be updated based on user input. Correspondingly, the method further comprises:
in response to a scene preference keyword inputted by a user, detecting whether the scene label in the virtual scene set is matched with the scene preference keyword;
deleting a virtual scene unsuccessfully matched from the virtual scene set according to a match result; and
if the number of virtual scenes successfully matched is less than a preset threshold, sending the scene preference keyword and the scene type to a data platform, and prompting supplementing the virtual scene set.

The scene preference keyword is key information for characterizing a scene preference of the user. For example, the scene preference keyword is “countryside”, “snow house”, “spaceship”.

Specifically, each virtual scene has a corresponding scene label, and matching the scene label with the scene preference keyword is performed; if the matching is unsuccessful, it is indicated that the virtual scene is not favored by the user and is deleted from the virtual scene set; and if the matching is successful, it is continued to determine whether the number of virtual scenes successfully matched is less than the preset threshold, if the number is less than the preset threshold, it is indicated that less virtual scenes favored by the user can be provided by the virtual scene set, and the scene preference keyword and the scene type are sent to the data platform, and supplementing the virtual scene set is prompted, thereby increasing the virtual scenes favored by the user.

Therefore, the virtual scene set is updated according to the user input, and the virtual scenes favored by the user are increased, so that the virtual scenes more favored by the user are presented to the user, and a personalized presentation requirement for the virtual scene is met.

In another implementation of the present disclosure, in the process of presenting the virtual scene in the virtual scene set, it is possible to switch to present different virtual scenes.

Correspondingly, the method further comprises:
in response to a switching instruction for scene presentation, performing switching presentation of different virtual scenes in the virtual scene set on at least part of physical objects in the physical object set.

Specifically, in the manner described above, it is possible to determine part of physical objects corresponding to each virtual scene in the virtual scene set, obtain a preset scene switching mode, and in response to the switching instruction for scene presentation, switch to present different virtual scenes according to the part of physical objects corresponding to each virtual scene.

The switching instruction refers to instruction information for instructing the electronic device to change a virtual scene. In some embodiments, the switching instruction may be an automatic switching instruction or a switching instruction generated based on a user trigger operation.

In one case, the in response to the switching instruction for scene presentation comprises:
in response to a detection that an environmental light brightness change value in the environment space is greater than or equal to a preset brightness threshold.

The environmental light brightness change value is used for determining whether there is sunset or sunrise at a position where the environment space is located. It can be understood that, if a current scene type is the daytime type and the environmental light brightness change value is greater than or equal to the preset brightness threshold, it is indicated that at the position where the environment space is located, time has changed from daytime to nighttime, thereby generating a switching instruction for scene presentation, and in response to the switching instruction for scene presentation, switching a virtual scene of the daytime type to a virtual scene of the nighttime type; if a current scene type is the nighttime type and the environmental light brightness change value is greater than or equal to the preset brightness threshold, it is indicated that at the position where the environment space is located, time has changed from nighttime to daytime, thereby generating a switching instruction for scene presentation, and in response to the switching instruction for scene presentation, switching a virtual scene of the nighttime type to a virtual scene of the daytime type.

In another case, the in response to the switching instruction for scene presentation comprises:
in response to a detection that the user performs a trigger operation on a scene switching control on a virtual device.
The trigger operation refers to a user operation for virtual scene switching.

It can be understood that, when a presented virtual scene is a sunny beach scene, if the user wants to experience a Nordic snow house scene, he triggers the scene switching control to generate a switching instruction for scene presentation, and in response to the switching instruction for scene presentation, the sunny beach scene is switched to the Nordic snow house scene.

In yet another case, the in response to the switching instruction for scene presentation comprises:
in response to a detection that the current time meets a preset presentation carousel time.

The presentation carousel time refers to a regular change time for virtual scene presentation.

Specifically, the presentation carousel times for a plurality of virtual scenes may be preset, for example, the plurality of virtual scenes include scenes such as a sunny beach, a Nordic snow house, and a countryside, so that inside an environment space, a switching instruction for scene presentation is generated every time it arrives at a presentation carousel time, and in response to the switching instruction for scene presentation, the scenes such as a sunny beach, a Nordic snow house, and a countryside are regularly switched.

Further, in the process of switching to present the virtual scenes, the method may further comprise:
in response to receiving a fixing-presentation instruction sent by the user, stopping performing the switching presentation.

The fixing-presentation instruction refers to a locking instruction for fixing the virtual scene, which is used for canceling the presentation carousel function. In some embodiments, the fixing-presentation instruction may include, but is not limited to, a voice instruction, and a manual instruction.

It can be understood that, when switching presentation is performed on virtual scenes, if a user favors a certain virtual scene, the locking instruction for stopping performing the switching presentation can be sent, so that the environment space fixes the virtual scene favored by the user, and the presentation carousel function is cancelled.

Therefore, switching presentation can be performed on the virtual scenes inside the environment space, so that the user experiences different virtual scenes, and diversified virtual scene experience requirements of the user are met. In the process of the switching presentation, the virtual scene favored by the user can also be fixed based on a trigger operation of the user, so that the virtual scene interaction experience of the user is further improved.

In some scenes, the virtual scene may also be presented simultaneously with background music matched with the virtual scene. Correspondingly, the method further comprises:
according to a virtual scene currently presented, playing background music matched with the virtual scene.

Specifically, each virtual scene may be preset with corresponding background music, and for the virtual scene currently presented, the background music matched therewith is found, and the virtual scene currently presented and the background music matched therewith are played simultaneously.

In other scenes, for the virtual scene currently presented, the background music matched with the virtual scene currently presented can be cancelled according to a mute instruction, so as to play the virtual scene mutely.

Therefore, the background music can be matched for the virtual scene to further enhance interestingness of virtual scene presentation, and the virtual scene can also be played mutely according to a user requirement, to improve the virtual scene interaction experience of the user.

Based on the same inventive concept as the above method embodiment, the present disclosure further provides a virtual scene presentation apparatus, and referring to FIG. 2, which is a schematic structural diagram of a virtual scene presentation apparatus provided in an embodiment of the present disclosure, the virtual scene presentation apparatus 200 comprises:
an identification module 201 configured to identify a physical object set in an environment space;
a determination module 202 configured to determine a scene type corresponding to the environment space;
an obtaining module 203 configured to obtain a virtual scene set associated with the scene type; and
a presentation module 204 configured to present a virtual scene in the virtual scene set on at least part of physical objects in the physical object set.

In an optional implementation, the determination module 202 comprises:
an obtaining unit configured to obtain time information and/or location information of the environment space; and
a determination unit configured to determine the scene type corresponding to the environment space according to the time information and/or the location information.

In an optional implementation, the scene type corresponding to the environment space is a daytime type or a nighttime type. In an optional implementation, the determination module 202 comprises:
a detection unit configured to detect whether there is a preset key object in the physical object set; and
a query unit configured to, if it is learned through detection that there is the key object, query preset scene type information corresponding to the key object, to determine the scene type corresponding to the environment space.

In an optional implementation, the scene type corresponding to the environment space is an office type, or a bedroom type, or a study room type.

In an optional implementation, the obtaining module 203 comprises:
a parsing unit configured to parse content of a candidate virtual scene, and extract a scene label of the candidate virtual scene; and
a screening unit configured to match the scene label with the scene type, and screen out a candidate virtual scene successfully matched, as the virtual scene set associated with the scene type.

In an optional implementation, the apparatus further comprises:
a detection module configured to, in response to a scene preference keyword inputted by a user, detect whether the scene label in the virtual scene set is matched with the scene preference keyword;
a deletion module configured to delete a virtual scene unsuccessfully matched from the virtual scene set according to a match result; and
a prompt module configured to, if the number of virtual scenes successfully matched is less than a preset threshold, send the scene preference keyword and the scene type to a data platform, and prompt supplementing the virtual scene set.

In an optional implementation, the presentation module 204 comprises:
a target physical object obtaining unit configured to obtain a target physical object from the physical object set according to indication information of the user;
an extraction unit configured to extract a current feature value of each pixel point of the target physical object;
a feature value obtaining unit configured to obtain a reference feature value corresponding to each pixel point of the target physical object according to a virtual scene to be presented; and
a comparison unit configured to compare the current feature value and the reference feature value of each pixel point of the target physical object, determine whether to update the current feature value according to a comparison result, and present the virtual scene in the virtual scene set by an update result.

In an optional implementation, the apparatus further comprises:
a switching presentation module configured to, in response to a switching instruction for scene presentation, perform switching presentation of different virtual scenes in the virtual scene set on the at least part of physical objects in the physical object set.

In an optional implementation, the in response to the switching instruction for scene presentation comprises:
in response to a detection that an environmental light brightness change value inside the environment space is greater than or equal to a preset brightness threshold; or
in response to a detection that the user performs a trigger operation on a scene switching control on a virtual device; or
in response to a detection that a current time meets a preset presentation carousel time.

In an optional implementation, the apparatus further comprises:
a stopping-switching-presentation module configured to, in response to receiving a fixing-presentation instruction sent by the user, stop performing the switching presentation.

In an optional implementation, the apparatus further comprises:
a music matching module configured to, according to a virtual scene currently presented, play background music matched with the virtual scene.

An embodiment of the present disclosure provides a virtual scene presentation apparatus, which identifies a physical object set in an environment space; determines a scene type corresponding to the environment space; obtains a virtual scene set associated with the scene type; and presents a virtual scene in the virtual scene set on at least part of physical objects in the physical object set. In this manner, various physical objects in the environment space can be flexibly combined to determine virtual scenes corresponding to different scene types, and therefore, the rendering solution for the virtual scene has more flexibility, so that various virtual scenes can be rendered, and diversified experience requirement of users for the MR scene are met.

In addition to the above method and apparatus, an embodiment of the present disclosure further provides a non-transitory computer-readable storage medium having therein stored instructions which, when run on a terminal device, cause the terminal device to implement the virtual scene presentation method according to an embodiment of the present disclosure.

An embodiment of the present disclosure further provides a computer program product comprising a computer program or instructions which, when executed by a processor, implements the virtual scene presentation method according to an embodiment of the present disclosure.

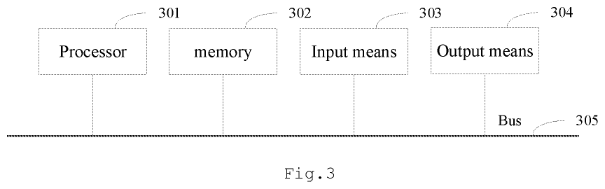

In addition, an embodiment of the present disclosure further provides a virtual scene presentation device, and referring to FIG. 3, the virtual scene presentation device may comprise:
a processor 301, a memory 302, an input means 303, and an output means 304. The number of the processor 301 in the virtual scene presentation device may be one or more, and one processor is taken as an example in FIG. 3. In some embodiments of the present disclosure, the processor 301, the memory 302, the input means 303, and the output means 304 may be connected through a bus 305 or others, wherein connection through bus 305 is taken as an example in FIG. 3.

The memory 302 may be configured to store a software program and module, and the processor 301 executes various functional applications and data processing of the virtual scene presentation device by running the software program and module stored in the memory 302. The memory 302 may mainly include a program storage area and a data storage area, wherein the program storage area may store an operating system, an application required for at least one function, and the like. Furthermore, the memory 302 may include a high-speed random access memory, and may also include a non-volatile memory, such as at least one magnetic disk storage device, flash memory device, or other non-volatile solid-state storage devices. The input means 303 may be configured to receive inputted number or character information and generate a signal input related to user settings and function controls of the virtual scene presentation device.

Specifically, in this embodiment, the processor 301 will load an executable file corresponding to one or more application's processes into the memory 302 according to the following instructions, and the processor 301 runs the application stored in the memory 302, thereby implementing various functions of the above virtual scene presentation device.

It should be noted that, relational terms such as “first” and “second”, herein, are only used for distinguishing one entity or operation from another entity or operation without necessarily requiring or implying any such actual relation or order between these entities or operations. Moreover, the term “include”, “comprise”, or any other variation thereof, are intended to encompass a non-exclusive inclusion, such that a process, method, article, or device including a list of elements includes not only those elements but also other elements not expressly listed, or elements inherent to such a process, method, article, or device. Without more limitations, an element defined by a statement “including one” does not exclude the presence of another identical element in the process, method, article, or device that includes the element.

The above contents are only specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but conform to the widest scope consistent with the principles and novel features disclosed herein.

What is claimed is:

1. A virtual scene presentation method, comprising:
identifying a physical object set in an environment space;
determining a scene type corresponding to the environment space;
obtaining a virtual scene set associated with the scene type; and
presenting a virtual scene in the virtual scene set on at least part of physical objects in the physical object set.

2. The method according to claim 1, wherein, the determining the scene type corresponding to the environment space comprises:
obtaining time information and/or location information of the environment space; and
determining the scene type corresponding to the environment space according to the time information and/or the location information.

3. The method according to claim 2, wherein, the scene type corresponding to the environment space is a daytime type or a nighttime type.

4. The method according to claim 1, wherein, the determining the scene type corresponding to the environment space comprises:
detecting whether there is a preset key object in the physical object set; and
if it is learned through detection that there is the key object, querying preset scene type information corresponding to the key object, to determine the scene type corresponding to the environment space.

5. The method according to claim 4, wherein, the scene type corresponding to the environment space is an office type, or a bedroom type, or a study room type.

6. The method according to claim 1, wherein, the obtaining the virtual scene set associated with the scene type comprises:
parsing content of a candidate virtual scene, and extracting a scene label of the candidate virtual scene; and
matching the scene label with the scene type, and screening out a candidate virtual scene successfully matched, as the virtual scene set associated with the scene type.

7. The method according to claim 6, further comprising:
in response to a scene preference keyword inputted by a user, detecting whether the scene label in the virtual scene set is matched with the scene preference keyword;
deleting a virtual scene unsuccessfully matched from the virtual scene set according to a match result; and
if the number of virtual scenes successfully matched is less than a preset threshold, sending the scene preference keyword and the scene type to a data platform, and prompting supplementing the virtual scene set.

8. The method according to claim 1, wherein, the presenting the virtual scene in the virtual scene set on at least part of physical objects in the physical object set comprises:
obtaining a target physical object from the physical object set according to indication information of the user;
extracting a current feature value of each pixel point of the target physical object;
obtaining a reference feature value corresponding to each pixel point of the target physical object according to a virtual scene to be presented; and
comparing the current feature value and the reference feature value of each pixel point of the target physical object, determining whether to update the current feature value according to a comparison result, and presenting the virtual scene in the virtual scene set by an update result.

9. The method according to claim 1, further comprising:
in response to a switching instruction for scene presentation, performing switching presentation of different virtual scenes in the virtual scene set on the at least part of physical objects in the physical object set.

10. The method according to claim 9, wherein, the in response to the switching instruction for scene presentation comprises:
in response to a detection that an environmental light brightness change value inside the environment space is greater than or equal to a preset brightness threshold; or
in response to a detection that the user performs a trigger operation on a scene switching control on a virtual device; or
in response to a detection that a current time meets a preset presentation carousel time.

11. The method according to claim 9, further comprising:
In response to receiving a fixing-presentation instruction sent by the user, stopping performing the switching presentation.

12. The method according to claim 1, further comprising:
according to a virtual scene currently presented, playing background music matched with the virtual scene.

13. A non-transitory computer-readable storage medium, having therein stored instructions which, when run on a terminal device, cause the terminal device to implement the steps of:
identifying a physical object set in an environment space;
determining a scene type corresponding to the environment space;
obtaining a virtual scene set associated with the scene type; and
presenting a virtual scene in the virtual scene set on at least part of physical objects in the physical object set.

14. A device, comprising: a memory, a processor, and a computer program stored in the memory and being runnable on the processor, the computer program, when executed by the processor, implements the steps of:
identifying a physical object set in an environment space;
determining a scene type corresponding to the environment space;
obtaining a virtual scene set associated with the scene type; and
presenting a virtual scene in the virtual scene set on at least part of physical objects in the physical object set.

15. The device according to claim 14, wherein the step of presenting the virtual scene in the virtual scene set on at least part of physical objects in the physical object set comprises:
obtaining a target physical object from the physical object set according to indication information of the user;
extracting a current feature value of each pixel point of the target physical object;
obtaining a reference feature value corresponding to each pixel point of the target physical object according to a virtual scene to be presented; and
comparing the current feature value and the reference feature value of each pixel point of the target physical object, determining whether to update the current feature value according to a comparison result, and presenting the virtual scene in the virtual scene set by an update result.

16. The device according to claim 14, wherein the computer program, when executed by the processor, implements the further step of:
in response to a switching instruction for scene presentation, performing switching presentation of different virtual scenes in the virtual scene set on the at least part of physical objects in the physical object set.

17. The device according to claim 16, wherein the in response to the switching instruction for scene presentation comprises:
in response to a detection that an environmental light brightness change value inside the environment space is greater than or equal to a preset brightness threshold; or
in response to a detection that the user performs a trigger operation on a scene switching control on a virtual device; or
in response to a detection that a current time meets a preset presentation carousel time.

18. The device according to claim 16, wherein the computer program, when executed by the processor, implements the further step of:
in response to receiving a fixing-presentation instruction sent by the user, stopping performing the switching presentation.

19. The device according to claim 14, wherein the computer program, when executed by the processor, implements the further step of:
according to a virtual scene currently presented, playing background music matched with the virtual scene.

20. The device according to claim 14, wherein the step of determining the scene type corresponding to the environment space comprises:
obtaining time information and/or location information of the environment space; and
determining the scene type corresponding to the environment space according to the time information and/or the location information.
